(19) United States
(12) Patent Application Publication
(10) Pub. No.: US 2018/0143103 A1
(43) Pub. Date: May 24, 2018

(54) METHOD FOR AUTOMATICALLY CHECKING AN INSTALLATION OF A COOKING APPLIANCE, COOKING APPLIANCE AND NETWORK

(71) Applicant: RATIONAL AG, Landsberg am Lech (DE)

(72) Inventors: Theodor TUMBRINK, Esslingen (DE); Markus GLÜCK, Wilmette, IL (US)

(21) Appl. No.: 15/821,636

(22) Filed: Nov. 22, 2017

(30) Foreign Application Priority Data
Nov. 23, 2016 (DE) 10 2016 122 642.4

(51) Int. Cl. G01M 99/00; G05B 15/02

(52) U.S. Cl. CPC G01M 99/008; G06Q 30/0283; G05B 15/02

(57) ABSTRACT

A method for automatically checking an installation of a cooking appliance that exchanges data with at least one control unit at least intermittently, in which at least one enable signal or blocking signal is produced as a function of installation data of the cooking appliance, where payment for the installation is enabled on production of the enable signal or is blocked on production of the blocking signal. A cooking appliance for performing such a method and a network having such cooking appliances.

### CROSS-REFERENCE TO RELATED APPLICATION

This application claims the benefit of priority to German Patent Application No. DE 10 2016 122 642.4, filed Nov. 23, 2016, which is incorporated herein by reference in its entirety for all purposes.

### BACKGROUND

### 1. Field

The following description relates to a method for automatically checking an installation of a cooking appliance that exchanges data with at least one control unit. The data exchange may be performed at least intermittently. In addition, the following description relates to a cooking appliance for performing such a method, as well as a network having a plurality of such cooking appliances.

### 2. Description of Related Art

A simple form of a network within the meaning of an example of the invention may include a cooking appliance which is temporarily connected by means of a data connection to a personal computer of the manufacturer of the cooking appliance. The data connection may be established via a telephone network, and the personal computer may take on the function of the control unit.

A network can also be realized in the form of a kitchen network. Kitchen networks having a plurality of cooking appliances are frequently used to increase efficiency and improve quality in a large kitchen. German Patent Application No. DE 10 2011 001 071 A1 describes that in order to facilitate sequencing, it can be gathered from display devices, which may be provided by a cooking appliance, when a cooking product is to be loaded or unloaded and where in the cooking chamber. Such measures are to be taken prior to the loading and/or subsequent to the unloading.

European Patent Application No. EP 2 213 175 A1 describes, due to an automatic communication of at least one cooking appliance with at least one merchandise management system, a method for determining a work process in the cooking appliance. The method can be automated and can be self-learning. In this case, an operator can, for example, select a particular menu having multiple cooking products and, depending on the requirements, can either manually enter the number of menus, which usually corresponds to the number of people to be cooked for, or can be given a suggestion regarding this via the merchandise management system to achieve optimal cooking. Thus, the menu can subsequently be prepared for the selected number. A self-learning process can accompany the consumption of the created menus. That is, the operator may manually enter whether there is an excessive amount or deficiency of individual cooking products for the various cooking products of the menu. As a result, the number of menus suggested by the merchandise management system, together with quantities of cooking products, is automatically adapted to this quantity information for future methods.

International Patent Application Publication No. WO 2008/077564 A1 describes a cooking appliance in which a server performs an exchange of data with the cooking appliance. A triggering command, which leads to the establishment of a connection between the server and the cooking appliance, can be given by the cooking appliance itself

Electronic levels for cooking appliances are also well known in the prior art. German Patent No. DE 10 2008 015 417 B1 describes an adjustment of an inclination of a cooking pot which can be carried out automatically or after confirmation by a display and/or operating device. A warning signal can be emitted if a malalignment is detected.

### SUMMARY

In an aspect, a method for automatically checking an installation of a cooking appliance includes exchanging data with at least one control unit at least intermittently.

This object may be achieved by automatically checking an installation of a cooking appliance that exchanges data with at least one control unit at least intermittently, in which at least one enable signal or blocking signal is produced as a function of installation data of the cooking appliance, where payment for the installation is enabled on production of the enable signal or is blocked on production of the blocking signal.

In an example, it can be envisaged that the installation data is at least partially entered by a fitter, in particular into the cooking appliance, preferably following authentication and/or identification. In another example, the installation data is captured at least partially by a measuring device, preferably automatically and/or at predefined first times.

The installation data may be transmitted in an encrypted form by the cooking appliance to the control device. This may be done automatically after triggering the transmission and/or at predefined second times. Also, the installation data may be stored at least intermittently in a storage device, preferably of the cooking appliance.

The installation data may be transmitted and/or stored, together with appliance master data, in particular the serial number of the cooking appliance, and/or service data and/or HACCP data.

In an example, in order to transmit the installation data through the cooking appliance, the cooking appliance may be connected intermittently to a transmission device. For example, a mobile device, a smartphone and/or a tablet computer. The enable signal or the block signal may be exclusively produced by the cooking appliance so that a remote input on a mobile device, in particular in order to instigate a payment, is avoided.

The installation data can be determined from data regarding the alignment of the cooking appliance. For example, data regarding the leveling of the cooking appliance, data regarding the installation site of the cooking appliance such as the installation altitude of the cooking appliance, data regarding the electrical connection, data regarding the gas connection such as the type of gas, data regarding the gas pressure, data regarding the water connection such as the water pressure, and/or data regarding the water quality such as the water hardness.

At least the data regarding the alignment of the cooking appliance may be taken into account on production of the enable signal or blocking signal.

The installation may take place in n steps, wherein n is a natural number starting from 1, and the steps are displayed automatically or upon request and/or after connecting the cooking appliance to an electricity, water and/or gas supply.

The display of the steps may include a displaying of instructions, nominal values of the data determining the installation data, the sequence of the steps and/or a set length of time for the installation, preferably for each step.

The i-th step may not be displayed until the conclusion of the (i−1)-th step has been captured or confirmed, where i is greater than 1 and less than or equal to n. The actual length of time for carrying out the steps, preferably an actual length of time for carrying out each step, may be captured, displayed, stored and/or evaluated.

Nominal values of the data determining the installation data and/or of values that characterize the installation site may be displayed. This may include data determined from the installation altitude, the geographical location, the water quality, the electrical connection, the gas quality, fire regulations and/or environmental standards at the installation site.

The steps may be displayed on a display device which is, in particular, provided by the cooking appliance and/or which communicates with the control unit.

A self-teaching and/or assessment of the installation as a function of the captured installation data, the installation site, a fitter and/or the captured actual length of time, preferably of each captured actual length of time, may be provided.

For example, the assessment may displayed, in particular on the display device, and/or is taken into account during payment for the installation.

In addition, an adjustment of the first times, of the second times and/or the nominal length(s) of time as a function of the captured installation data and/or the captured actual length of time, preferably of each captured actual length of time, may be provided.

In another aspect, a cooking appliance includes at least a storage device, a display device, an input device, a measuring device, a control or regulating device and an interface with at least one separate control device, the cooking appliance being set up to perform a method according to the invention.

The interface may make possible a connection via the internet between the cooking appliance and the control device and/or a router, in particular a GPRS router, for wireless data transmission.

In order to capture installation data, the measuring device may include a leveling sensor for capturing an alignment of the cooking appliance and/or at least one sensor for establishing the installation site and/or for the electricity, gas and/or water connection.

In a further aspect, a network, such as a kitchen network, may include a plurality of cooking appliances and at least one control device which can be connected to the cooking appliances at least intermittently and which is, in particular, executed with or connected to a merchandise management system.

At least one advantage of the invention is consequently based on the surprising finding that not only is it possible to be assured that a cooking appliance has been installed correctly through installation data being checked by evaluating an entry made by a fitter and/or output data of a measuring device and a message being issued when the relevant check is successfully completed, but this message can also provide additional feedback to the fitter. Further, such a message can save the operator of the network in which the cooking appliance is being used a work step, in that this message may trigger payment of the installation costs. In this case, the fitter additionally receives automatic training while the operator saves time and costs. The operator can be an appliance manufacturer, an appliance dealer or a restaurant chain.

The fitter can, during the installation and/or entry to confirm the same, have recourse to known data. Such data may be recorded electronically in the cooking appliance, a smartphone, a tablet or the like. The measuring device can include a leveling sensor for capturing a correct alignment of the cooking appliance and/or at least one sensor for establishing the installation altitude, the type of gas, the gas pressure, the water pressure and/or the water quality such as water hardness.

The installation data can be stored, preferably together with service data and appliance master data.

### DETAILED DESCRIPTION

Further features and advantages of the inventions are set out in the following description, in which embodiments of a method according to the invention are explained by way of example.

Following delivery of a cooking appliance by an appliance manufacturer to a customer, the cooking appliance is unpacked and installed at the destination in a kitchen. Therefore, as a rule, the person installing the cooking appliance, referred to as the fitter, then carries out a series of measures in accordance with an installation checklist, which are referred to hereinafter as installation steps. These installation steps can be displayed in paper form or in electronic form, e.g. on a tablet or smartphone. It is also conceivable that the installation steps are provided after connecting the device to an electricity supply and initial commissioning directly on a display device of the cooking appliance.

The cooking appliance can be, for example, a cooking appliance for supplying a cooking product with hot air and/or steam or a so-called tillable ladle having a crucible. In this case, an electric heating device and/or a gas-powered heating device can be used.

The measures to be carried out by the fitter include, in addition to an alignment of the cooking appliance, such as the crucible of a tillable ladle, e.g. a checking of the water pressure in the building plumbing, establishing the water hardness and entering the established value in the cooking appliance, checking the type of gas, instructing the customer in safety aspects and the like.

In a preferred embodiment of the method, the cooking appliance guides the fitter through the installation. This means that each installation step has to be confirmed. In this case, the next, i.e. the (i+1)-th installation step is always only displayed following confirmation of the completion of the i-th installation step. For example, it must first of all be documented that packaging material has been disposed of properly and safety notices have been complied with. In the next steps, the cooking appliance additionally indicates the respective length of time for completion and preferably also records the length of time up to execution of the steps. As a result, the actual time required can be established within the framework of a statistical analysis. Plausibility checks can therefore also be carried out. If, as an example, an entry is made by the fitter too quickly, this could be an indication that the installation has not been carried out correctly.

The process of aligning a cooking appliance requires, for example, a certain length of time and can be carried out using an electronic level as is described by German Patent No. DE 10 2008 015 417 B1. The electronic level can additionally be connected to a storage device in order to automatically store data. In addition, it is preferred that the data regarding the alignment are stored together with the serial number of the cooking appliance and HACCP data.

Following completion of each step of the installation, the fitter has to document this in the appliance. For example, this may be documented in a specific technology area with password protection which is not accessible to the customer. To this end, the steps are described as instructions in text and/or images in the appliance, namely on the display device thereof, and are provided, for example, with a confirmation box. The fitter may also have to electronically complete a table or a form. The fitter must also identify himself, for example by entering his name or his employee identification or by including biometric data such as a fingerprint. Other ways of authenticating data entries such as entering passwords or the like are also possible.

Once the documentation has been correctly completed, the appliance may automatically transmit a first enable signal to the appliance manufacturer. The transmission can take place by means of a data connection through the cooking appliance itself or other known connection techniques, such as from the cooking appliance to a mobile radio device or similar, and then to the appliance manufacturer. The enable signal may be linked to the unique serial number of the cooking appliance. Only if this signal is noted by the appliance manufacturer in the appliance master data is a second enable signal created, which makes it possible to settle an invoice which is subsequently received by the appliance manufacturer from the fitter. Without this enable signal, a payment is blocked.

The enabling can of course also take place in the same way in accordance with the invention in the event of a dealer acting as an intermediary. Blocking signals can also be sent instead of enable signals, if e.g. a leveling sensor does not capture a correct alignment of the cooking appliance, so that a payment to the fitter is blocked.

The data exchange can take place in the same way as described in International Patent Application Publication No. WO 2008/077564 A1.

The features of the invention, which are disclosed in the preceding description, as well as the claims, can be essential, both individually and in any combination whatsoever, to the realization of the invention in its various embodiments.

What is claimed is:

1. A method for automatically checking an installation of a cooking appliance that exchanges data with at least one control unit at least intermittently, comprises
producing at least one enable signal or blocking signal as a function of installation data of the cooking appliance; and
in response to an enable signal being produced, enabling payment for the installation, or in response to a blocking signal being produced, blocking payment for the installation.

2. The method of claim 1, wherein at least one of
installation data is at least partially entered by a fitter into the cooking appliance following authentication or identification, and
the installation data is captured at least partially by a measuring device by at least one of automatically and at predefined first times.

3. The method of claim 1 or 2, wherein at least one of
the installation data is transmitted, in an encrypted form, by the cooking appliance to the control device in response to at least one of triggering the transmission and/or at predefined second times, and
the installation data is stored at least intermittently in a storage device.

4. The method of claim 3, further comprising at least one of transmitting and storing, together with appliance master data, at least one of a serial number of the cooking appliance, service data, and HACCP data.

5. The method of claim 1, further comprising connecting the cooking appliance at least intermittently to a transmission device including at least one of a mobile device, a smartphone and a tablet computer in order to transmit the installation data through the cooking appliance.

6. The method of claim 1, wherein the installation data is determined from at least one of
data regarding the alignment of the cooking appliance including regarding the leveling of the cooking appliance;
data regarding the installation site of the cooking appliance including the installation altitude of the cooking appliance;
data regarding at least one of the electrical connection and the gas connection including the type of gas or gas pressure;
data regarding the water connection including the water pressure; and
data regarding the water quality including the water hardness.

7. The method of claim 6, wherein at least the data regarding the alignment of the cooking appliance is taken into account upon production of the enable signal or blocking signal.

8. The method of claim 1, wherein the installation takes place in n steps, n is a natural number starting from 1, and steps are displayed automatically, upon request, and/or after connecting the cooking appliance to at least one of electricity, water and gas supply.

9. The method of claim 8, wherein the display of the steps comprises a displaying of at least one of instructions, nominal values of the data determining the installation data, a sequence of the steps, and a set length of time for the installation including for each step.

10. The method of claim 8 or 9, wherein at least one of
the i-th step is not displayed until the conclusion of the (i−1)-th step has been captured or confirmed, i being greater than 1 and less than or equal to n, and
an actual length of time for carrying out the steps, including an actual length of time for carrying out each step, is at least one of captured, displayed, stored and evaluated.

11. The method of claim 1, further comprising at least one of
displaying of nominal values of data determining the installation data; and
displaying of values that characterize at least one of an installation site including an installation altitude, a geographical location, a water quality, an electrical connection, a gas quality, a fire regulation, and environmental standards at the installation site.

12. The method of claim 1, wherein steps are displayed on at least one of a display device provided by the cooking appliance and a display device which can communicate with the control unit.

13. The method of claim 1, further comprising performing a self-teaching or assessment of the installation as a function of at least one of captured installation data, an installation site, a fitter, and captured actual length of time including of each captured actual length of time.

14. The method of claim 13, further comprising at least one of
displaying the assessment on a display device; and
taking the assessment into account during payment of the installation.

15. The method of claim 1, further comprising adjusting at least one of first times, second times and nominal periods of time as a function of at least one of captured installation data and captured actual length of time including each captured actual length of time.

16. A cooking appliance, comprising
a storage device;
a display device;
an input device;
a measuring device;
a control or regulating device; and
an interface comprising one separate control device,
wherein the cooking appliance is configured to perform a method according to claim 1.

17. The cooking appliance of claim 16, wherein the interface allows a connection via internet between the cooking appliance and at least one of a control device and a router including a GPRS router, for wireless data transmission.

18. The cooking appliance of claim 16 or 17, wherein the measuring device for capturing installation data comprises at least one of a leveling sensor for capturing an alignment of the cooking appliance, a sensor for establishing an installation site, and a sensor for detecting at least one electricity, gas and water connection.

19. A network including a kitchen network, comprising
a plurality of cooking appliances according to claim 16; and
at least one control device which can be connected at least intermittently to the cooking appliances and which is executed with or connected to a merchandise management system.
